(19) United States
(12) Patent Application Publication
(10) Pub. No.: US 2014/0204731 A1
(43) Pub. Date: Jul. 24, 2014

(54) MULTIPROTOCOL LABEL SWITCHING RING PROTECTION SWITCHING METHOD AND NODE DEVICE

(71) Applicant: Jinrong Ye, Beijing (CN)

(72) Inventor: Jinrong Ye, Beijing (CN)

(73) Assignee: Hangzhou H3C Technologies Co., Ltd., Hangzhou, Zhejiang (CN)

(21) Appl. No.: 14/236,028

(22) PCT Filed: Sep. 13, 2012
(86) PCT No.: PCT/CN2012/081322

§ 371 Date: Jan. 29, 2014

(30) Foreign Application Priority Data
Sep. 30, 2011 (CN) 201110300112.5

(51) Int. Cl. H04L 12/703

(52) U.S. Cl. CPC H04L 45/28
USPC 370/222

(57) ABSTRACT

According to an example, a MPLS ring protection switching method is applied to each node in an MPLS TP ring. In the method, an MPLS forwarding table entry configured for a working LSP and an MPLS forwarding table entry configured for a backup LSP of the working LSP are added into a first table, an MPLS forwarding table entry formed by cross connecting the working LSP and the backup LSP is added into a second table, a packet is received, the first table is searched when the node is in a normal forwarding state, and the packet is forwarded by using an MPLS forwarding table entry in the first table, the second table is searched when the node device is in a protection forwarding state, and the packet is forwarded by using an MPLS forwarding table entry in the second table.

### BACKGROUND

For facilitating understanding, explanations of a few terms are given as follows.

Multiprotocol label switching (MPLS) is a mechanism that directs packets based on labels.

Forwarding Equivalence Class (FEC) is an important concept in MPLS. MPLS is a forwarding mechanism based on classification of packets that classifies packets sharing a certain feature (i.e., the same destination or the same quality of service and so on) into the same class, which is referred to as an FEC. Packets in the same FEC will go through the same processing in an MPLS network.

Next hop Label Forwarding Entry (NHLFE) is adopted in MPLS forwarding. An NHLFE may include: a next hop of a packet, an operation to be performed on the packet's label stack (swap a label, or dispose a label, or impose one or multiple new labels) and other information such as data link encapsulation information.

An associated bidirectional tunnel is formed between two unidirectional Label Switched Paths (LSP) associated with each other at endpoints of the tunnel. The two unidirectional paths are deployed, monitored, and protected independently, and may consist of different physical paths or the same physical path.

In a co-routed bidirectional tunnel, the path in one direction uses the same physical path with the path in the other direction, and the two paths are deployed, monitored, and protected together.

MPLS proposed by the Internet Engineering Task Force (IETF) is a new technique for Internet backbone network. MPLS introduces connection-oriented label switching into the connection-less IP network, integrates layer-3 routing techniques with layer-2 switching techniques, and maintains the flexibility of IP routing and simplicity of layer-2 switching at the same time. MPLS lies between the data link layer and the network layer, and can be built on various types of data link layer protocols, such as Point to Point (PPP), Asynchronous Transfer Mode (ATM), Frame Relay, Ethernet etc. MPLS provides connection-oriented services for various network layer techniques, such as IPv4, IPv6, IPX etc.

MPLS TP (MPLS transport profile) is a connection-oriented Packet Transport Network (PTN) technique. It is an extension of MPLS with enhanced support for OAM, protection switching and QoS. Due to the strong increase in demand for packet data services, conventional telecom operators are considering using a Packet Transport Network (PTN), such as MPLS TP, for performing wired and wireless services.

### BRIEF DESCRIPTION OF THE DRAWINGS

Features of the present disclosure are illustrated by way of example and not limited in the following figure(s), in which like numerals indicate like elements, in which:

FIG. 1a is a schematic diagram illustrating a conventional MPLS TP ring.

FIG. 1b is a schematic diagram illustrating a link failure in a conventional MPLS TP ring.

FIG. 2 is a flowchart illustrating a basic process of a method according to an example of the present disclosure.

FIG. 3 is a schematic diagram illustrating a working LSP and a backup LSP according to an example of the present disclosure.

FIG. 4a is a schematic diagram illustrating different forms of an FTN entry according to an example of the present disclosure.

FIG. 4b is a schematic diagram illustrating a simple description of an FTN entry according to an example of the present disclosure.

FIG. 4c is a schematic illustrating different forms of an ILM entry according to an example of the present disclosure.

FIG. 4b is a schematic diagram illustrating a simple description of an ILM entry according to an example of the present disclosure.

FIG. 5 is a schematic diagram illustrating packet forwarding using a cross connection according to an example of the present disclosure.

FIGS. 6a to 6f are schematic diagrams illustrating an N table and a P table according to an example of the present disclosure.

FIGS. 7a to 7d are schematic diagrams illustrating an N table and a P table according to an example of the present disclosure.

FIG. 8 is a block diagram illustrating a structure of an apparatus according to an example of the present disclosure.

FIG. 9 is a block diagram illustrating a structure of an apparatus according to an example of the present disclosure.

### EXAMPLES

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Ring-shaped networks have high reliability and excellent self-healing capabilities, thus the ring topology is widely adopted in networks. Network operators wish to apply MPLS TP to ring-shaped networks because a large amount of network segments in current access networks and converging networks are ring-shaped fiber networks. The industry is therefore making an effort to find a MPLS TP solution for ring networks which is simple to plan, easy to deploy and consumes less resources.

The T-MPLS Shared Protection Ring standard defined in ITU-U G8132 is described as follows.

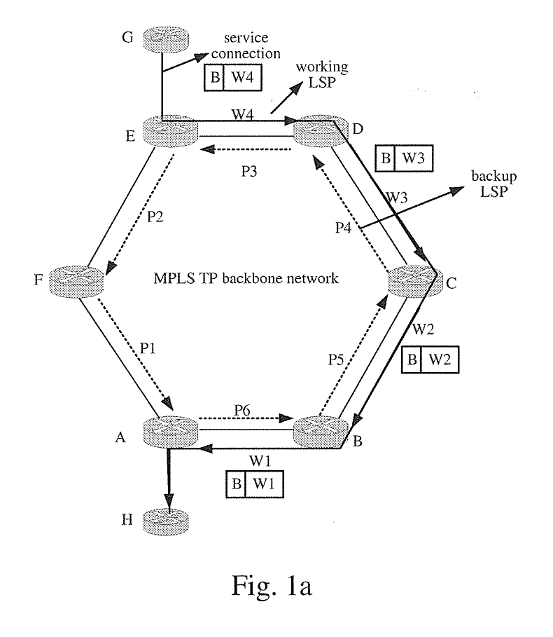

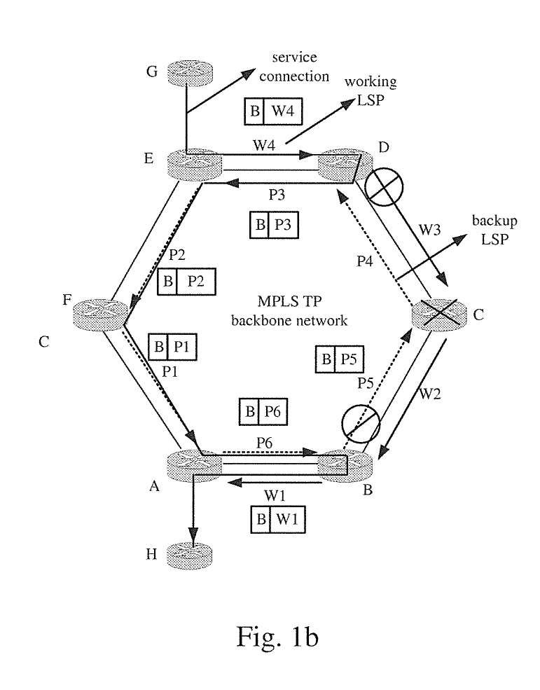

FIG. 1a is a schematic diagram illustrating a conventional MPLS TP ring. As shown in FIG. 1a, nodes A to F form a ring. Node E is connected to an underlying device G, and node A is connected to an underlying device H. A solid thin directionless line in FIG. 1 a represents a service connection between device G and device H. In FIG. 1a, a clockwise working Label Switched Path (LSP) is established with node A as the egress node and node E as the ingress node (the solid thick directional line shown in FIG. 1a): E→D→C→B→A. Generally, a working LSP is not a ring. The working labels corresponding to the working LSP (the labels imposed in a packet before it was sent from the nodes) are: [W4]→[W3]→[W2]→[W1].

In normal conditions, an ingress node of a working LSP maps a packet received from other ports (other than the ports via which the node is connected with adjacent nodes on the MPLS TP ring, i.e., ports via which the node is connected with devices not on the ring). An example of a forwarding process applied to the working LSP of FIG. 1a is as follows:

(1) Node E receives a packet from device G, maps the packet to a working LSP according to FEC in the packet, imposes a working label W4 into the packet, and forwards the packet.

(2) Node D receives the packet, swaps the working label W4 for the working label W3 and forwards the packet.

(3) Node C receives the packet, swaps the working label W3 for the working label W2 and forwards the packet.

(4) Node B receives the packet, swaps the working label W2 for the working label W1 and forwards the packet.

(5) Node A receives the packet, disposes the working label W1, and forwards the packet to an out-of-ring device H.

In order to improve the network reliability, it is desirable to establish dedicated backup LSPs for certain specific working LSPs. A backup LSP transports data in the opposite direction to that of the working LSP. A backup LSP may be a closed loop. Taking the working LSP of FIG. 1a as an example, FIG. 1b shows a counterclockwise backup LSP which is in the opposite direction of the working LSP: A→B→C→D→E→F→A, and corresponding backup labels are [P6]→[P5]→[P4]→[P3]→[P2]→[P1]→[P6]. [P6]→[P5] represents that when the label in a received packet is P6, the label P6 is disposed and a label P5 is imposed, i.e., the label P6 is replaced by the label P5.

Thus, when a failure occurs in the working LSP, traffic is switched to the backup LSP. An example switching process when the link between node D and node C on the working LSP in FIG. 1b is described below. The switching process for a node failure is similar.

(1) Node D swaps a working label W4 in a packet for the backup label P3 (instead of the working label W3), and forwards the packet.

(2) Node E receives the packet, swaps the backup label P3 with the backup label P2 and forwards the packet.

(3) Node F receives the packet, swaps the backup label P2 with the backup label P1 and forwards the packet.

(4) Node A receives the packet, swaps the backup label P1 for the backup label P6 and forwards the packet.

(5) Node B receives the packet, swaps the backup label P6 for the backup label P5 and forwards the packet.

(6) Node C receives the packet, swaps the backup label P5 for the backup label W2 and forwards the packet.

(7) Node B receives the packet, swaps the working label W2 for the working label W1 and forwards the packet.

(8) Node A receives the packet, disposes the working label W1, and forwards the packet to a device H which is not on the ring.

In the above description, the label operations performed by the nodes on the packet, e.g., the label swapping and label disposing, are all implemented based on forwarding tables maintained in the nodes. The forwarding table in an ingress node is an FEC To NHLFE (FTN) table, and the forwarding table in a node other than an ingress node is an Incoming Label Map (ILM) table. When traffic is switched from a working LSP to a backup LSP, a previous FTN table or ILM table (referred to as a forwarding table) should no longer be used. The forwarding table needs to have certain entries updated, and the updated forwarding table entries are used for performing operations on received packets, e.g., swapping a label, disposing a label, etc. When multiple working LSPs traversing the same node are switched over, the node needs to update entries corresponding to the multiple working LSPs switched to respective backup LSPs in the forwarding table one by one. The update process prolongs the time during which the traffic is interrupted and impairs the self-curing capability of the network.

An example provides a method for MPLS TP ring protection switching and a node in an MPLS TP ring so as to reduce the time during which the traffic is interrupted.

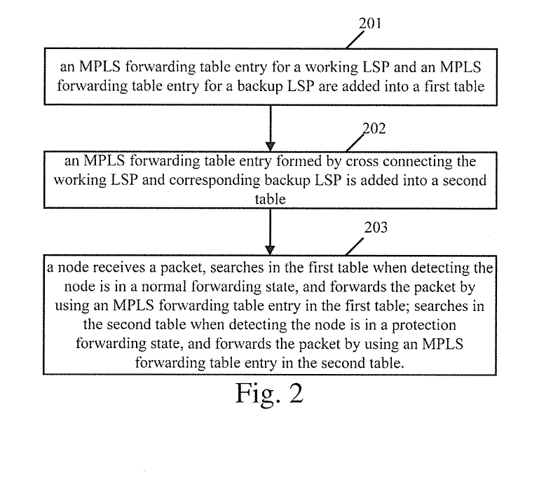

Referring to FIG. 2 there is shown a flowchart illustrating a basic process according to an example. In FIG. 2, each node in the MPLS TP ring may perform the following procedures.

In block 201, an MPLS forwarding table entry for a working LSP and an MPLS forwarding table entry for a backup LSP are added into a first table.

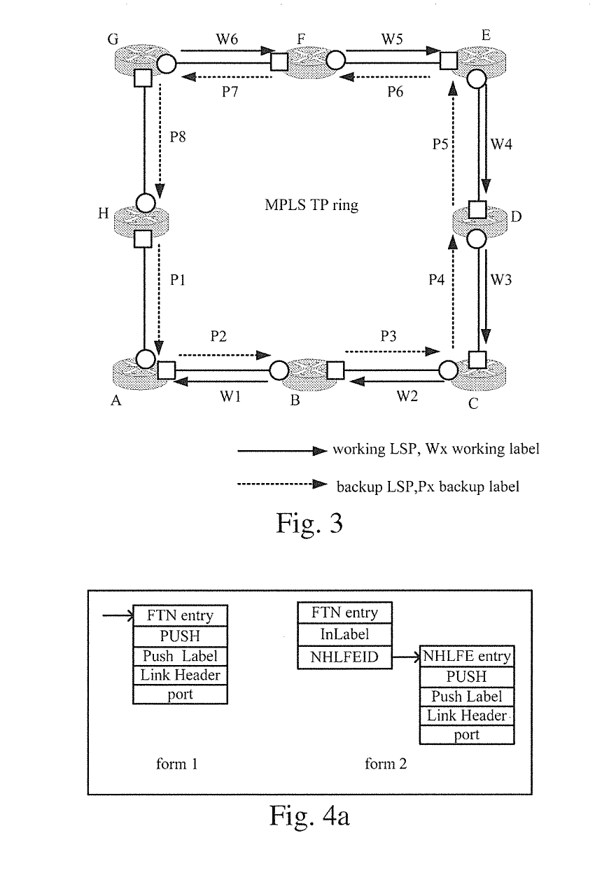

The direction of the backup LSP in block 201 is opposite to the direction of the working LSP. The backup LSP is a closed loop. As shown in FIG. 3, the nodes G→F→E→D→C→B→A in the clockwise direction is the working LSP, corresponding working labels are [W6]→[W5]→[W4]→[W3]→[W2]→[W1]; the nodes A→B→C→D→E→F→G→H→A in the counterclockwise direction is the backup LSP of the working LSP, and corresponding backup labels are [P2]→[P3]→[P4]→[P5]→[P6]→[P7]→[P8]→[P1]→[P2].

The MPLS forwarding table entry for the working LSP and the MPLS forwarding table entry for the backup LSP will be described below in detail.

In block 202, an MPLS forwarding table entry formed by cross connecting the working LSP and corresponding backup LSP is added into a second table.

In block 203, a node receives a packet, detects whether the node is in a normal forwarding state or a protection forwarding state, searches in the first table when the node is detected to be in the normal forwarding state, and forwards the packet by using an MPLS forwarding table entry in the first table; searches in the second table when the node is detected to be in the protection forwarding state, and forwards the packet by using an MPLS forwarding table entry in the second table.

The process shown in FIG. 2 is described in detail by referring to an example.

Before describing the process of FIG. 2, operations performed before and after a packet is forwarded in an MPLS TP ring are firstly introduced.

The processing of a packet entering the ring performed by an ingress node of a working LSP may include: mapping a packet received from a device not on the MPLS TP ring onto a working LSP on the MPLS TP ring. The above processing at least includes imposing a label into the packet.

The process of transporting a packet in the ring may include: a node forwards a packet received from an adjacent node on the MPLS TP ring to another adjacent node on the MPLS TP node. The above process is performed by a transit node on the working LSP and may include label swapping.

The processing of a packet exiting the ring may include: a node forwards a packet received from an adjacent node on the MPLS TP ring to a device not on the MPLS TP ring instead of forwarding the packet to another node on the MPLS TP ring. An egress node of a working LSP performs the above processing. The above processing may at least include disposing of a label.

According to the above three types of processing in an MPLS TP ring, nodes on an MPLS TP ring may be classified into ingress node, transit node, and egress node. In an example, a backup LSP is a closed loop, thus all processing performed on the backup LSP is the processing of transporting a packet in the ring, and all nodes on the backup LSP are transit nodes.

MPLS forwarding table entries in the above different types of nodes (e.g., ingress nodes, transit nodes, and egress nodes) are different.

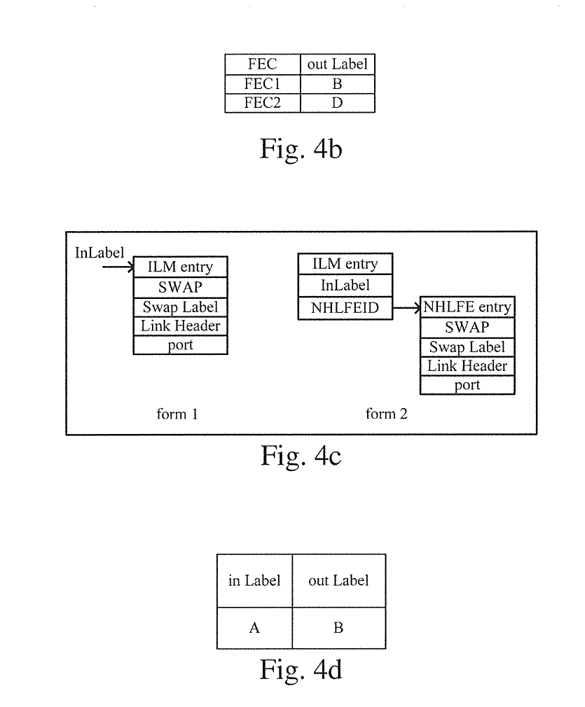

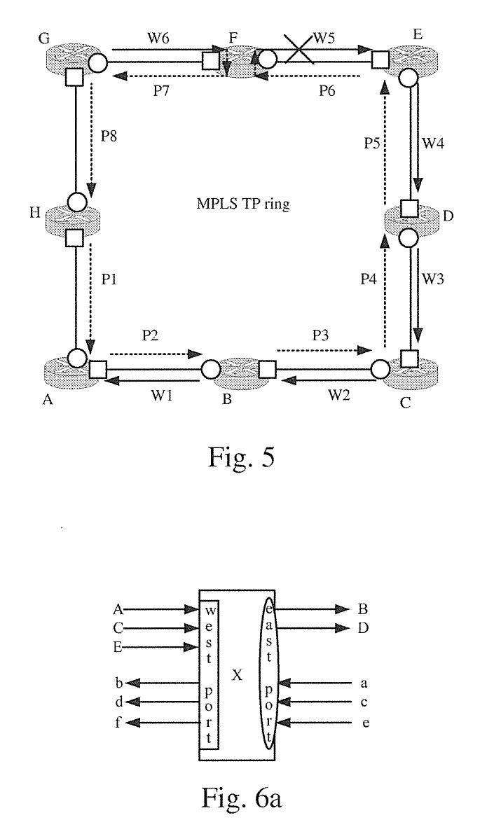

When a node is an ingress node of a working LSP, an MPLS forwarding table entry configured in the node for the working LSP is referred to as an FTN entry. An FTN entry may be in different forms, such as the form 1 and form 2 shown in FIG. 4a. An example FTN entry may be as shown in FIG. 4b, which may include a relation that associates an FEC with label information. The FEC refers to the FEC of a specific working LSP, in which the outgoing Label (oL) information indicates the label carried in a packet when the packet is sent.

When a node is not an ingress node of a working LSP, such as when the node is a transit node or an egress node on a working LSP, an MPLS forwarding table entry configured in the node for the working LSP is referred to as an ILM entry. An ILM entry may take different forms, such as the form 1 and form 2 shown in FIG. 4c. An example of an ILM entry may be as shown in FIG. 4d. An ILM entry may include a relation that associates information of an incoming label (iL) with information of an oL. The incoming label (iL) represents a label in a received packet and the oL information indicates the label in the packet when the packet is sent, i.e., the oL replaces the iL. When the oL information is Null, this is an indication that the node is an egress node that is to dispose the label in the packet.

For each backup LSP, an MPLS forwarding table entry configured in the node for the backup LSP is an ILM entry.

The first table in block 201 and the second table in block 202 are described below based on the above description of the MPLS forwarding table entry for a working LSP and the MPLS forwarding table entry for a backup LSP.

For simplicity, in the following description, the first table is denoted by a table N, and the second table is denoted by a table P.

The table N is a forwarding table for normal forwarding, and may be especially designed for MPLS TP rings. The table P is a forwarding table especially designed for MPLS TP rings, may be structurally different from, or the same with, that of the table N.

Regarding a node (denoted by node X), when the node is a transit node or an egress node of a working LSP (denoted by LSP1), block 201 may specifically include: adding an ILM entry configured for LSP1 into the table N, and adding an ILM entry configured for a backup LSP of the LSP1 into the table N.

Accordingly, block 202 may specifically include:

setting oL information in the ILM entry for the LSP1 to be oL information of the backup LSP corresponding to LSP1, setting oL information in the ILM entry for the backup LSP of LSP1 to be oL information of LSP1, and inserting the ILM entries into the table P.

Through the block 202, a cross connection of the working LSP and the backup LSP is implemented. The cross connection is for: (1) a node on the MPLS TP ring forwards a packet received from the working LSP to the backup LSP, and forwards a packet received from the backup LSP to the working LSP when detecting the connection with the adjacent node is disconnected; (2) a conventional switching process needs time to implement the switching between the local node and an adjacent node when the local node detects it is disconnected from the adjacent node, and a temporary loop may be formed during the process; by adopting the cross connection, e.g., when the node F detects a failure or performs switching prior to that of the node E, the node F may forward packets by using the cross connection, thus avoiding formation of a temporary forwarding loop.

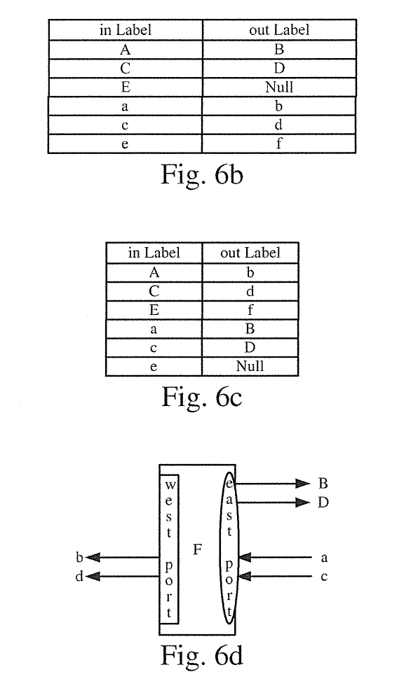

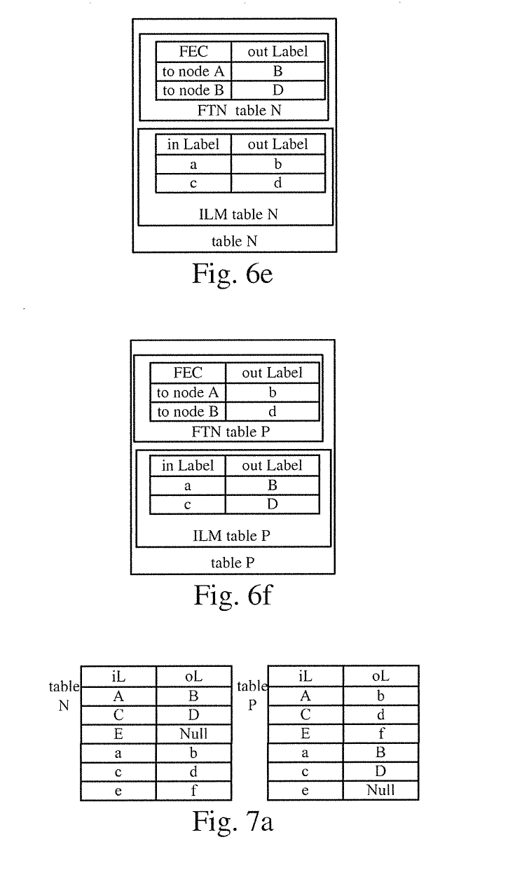

Taking the schematic diagram of an LSP traversing node X shown in FIG. 6a as an example, three working LSPs traverse node X in FIG. 6a, i.e., LSP a, LSP b, and LSP c. In LSP a and LSP b, node X is a transit node; in LSP c, node X is an egress node. The ILM entries configured in node X for the working LSPs may include:

an ILM entry for LSP a, where the iL is A, the oL is B;

an ILM entry for LSP b, where the iL is C, the oL is D;

an ILM entry for LSP c, where the iL is E, the oL is set to be Null.

Accordingly, three backup LSPs corresponding to the three working LSPs also traverse node X, and ILM entries for the backup LSPs may include:

an ILM entry for LSP d, which is a backup for LSP a, where the iL is a, the oL is b;

an ILM entry for LSP e, which is a backup for LSP b, where the iL is c, the oL is d;

an ILM entry for LSP f, which is a backup for LSP d, where the iL is e, the oL is f.

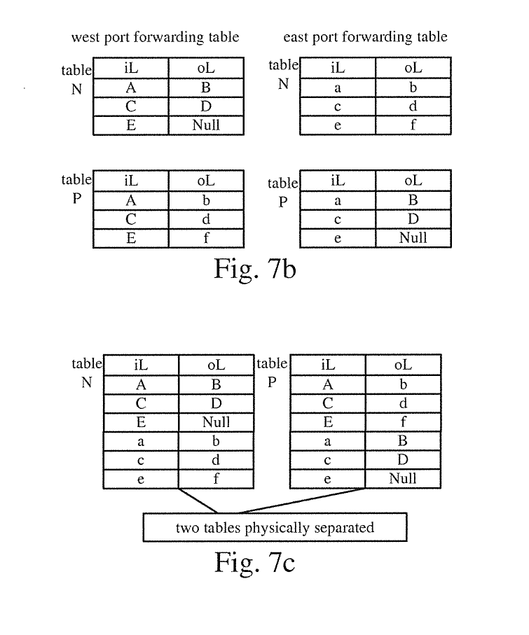

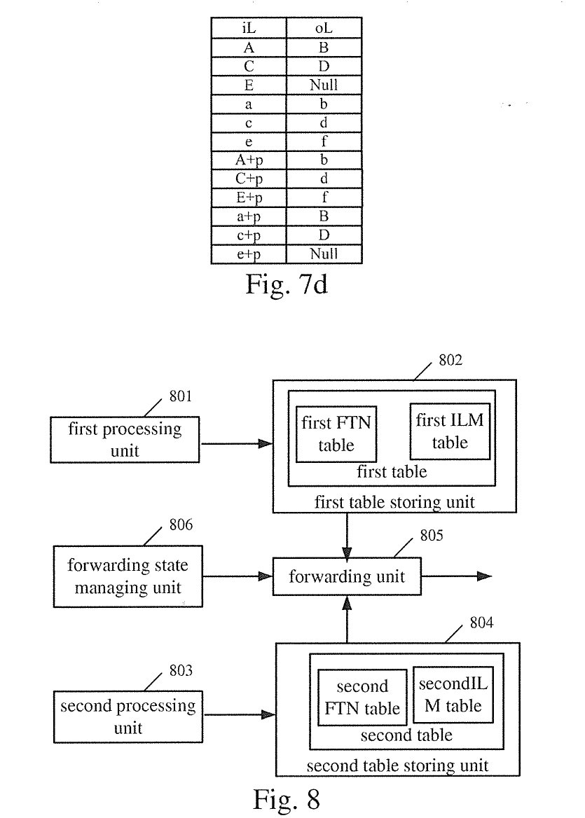

The table N shown in FIG. 6b may be obtained by performing the processing in block 201, and the table P shown in FIG. 6c may be obtained by performing the processing in block 202. Each pair of table N and table P may correspond to a port linking node X with the MPLS TP ring, i.e., for each port of node X, a table N and a table P may be established. A table N and a table P established for a port are independent from table N and table P established for another port. FIG. 7b illustrates a table N and a table P of a port facing the west in node X, and a table N and a table P of a port facing the east in node X. In another example, node X may not separately store tables N for multiple ports and tables P for multiple ports, as shown in FIG. 7a. There are no restrictions in this aspect.

The table N and the table P may be physically separated tables as shown in FIG. 7c, or may be in the same physical storage and logically separated as shown in FIG. 7d. If the table N and the table P are in the same physical storage and logically separated, it is desirable to add a mark to the MPLS forwarding table entry formed by cross connecting the working LSP and the backup LSP. For example, the mark p in an entry shown in FIG. 7d represents that the entry is the MPLS forwarding table entry formed by cross connecting the working LSP and the backup LSP.

The table N shown in FIG. 6b and the table P shown in FIG. 6c are both referred to as ILM forwarding tables. For facilitating description, the table N shown in FIG. 6b is referred to as ILM table N, and the table P shown in FIG. 6c is referred to as ILM table P.

When node X is an ingress node of a working LSP (denoted by LSP1), there are two types of table N: one is an FTN table, denoted by FTN table N, for storing FTN entries for LSP1; the other is an ILM table, denoted by ILM table N, for storing ILM entries for a backup LSP of LSP1. This is because nodes on any backup LSP are all transit nodes, and MPLS forwarding table entries configured for the LSP are all ILM entries, while any working LSP has an ingress node in which MPLS forwarding table entries configured for the working LSP are FTN entries which are different from the ILM entries in a transit node or an egress node and need to be distinguished.

Correspondingly, there are also two types of table P, one is an FTN table, denoted by FTN table P, for storing FTN entries formed by cross connecting LSP1 and corresponding backup LSP; the other is an ILM table, denoted by ILM table P, for storing ILM entries formed by cross connecting LSP1 and corresponding backup LSP.

When node X is an ingress node of a working LSP (denoted by LSP1), block 201 may specifically include: adding an FTN entry configured for LSP1 into the FIN table N, and adding an ILM entry configured for a backup LSP of LSP1 into the ILM table N.

Accordingly, block 202 may specifically include: The oL information in an FTN entry configured for LSP1 is set to be the oL information for the backup LSP of LSP1, and the FTN entry is added to the FTN table P. The oL information in an ILM entry configured for the backup LSP of LSP1 is set to be the oL information for LSP1, and the ILM entry is added into the ILM table P. Through the block 202, cross connection between the working LSP and the backup LSP is implemented.

Taking the LSP traversing node X shown in FIG. 6d as an example, there are two working LSPs with node X as the ingress node in FIG. 6d, i.e., LSP g and LSP h. FTN entries configured for the working LSPs may include:

(1) an FTN entry configured for LSP g, where FEC is set to be to destination node A, the oL is B;

(2) an FTN entry configured for LSP h, where FEC is set to be to destination node B, the oL is D.

Accordingly, two backup LSPs corresponding to the two working LSPs also traverse node X, and ILM entries for the backup LSPs may include:

(3) an ILM entry for LSP i which is backup for LSP g, where the iL is a, the oL is b;

(4) an ILM entry for LSP j which is backup for LSP h, where the iL is c, the oL is d.

The table N shown in FIG. 6e may be obtained by performing the processing in block 201, and the table P shown in FIG. 6f may be obtained by performing the processing in block 202.

In an MPLS TP ring, each node may serve as an ingress node of a working LSP and at the same time as a transit node or egress node of another working LSP. Therefore, each node may be configured with the following four types of tables: an FTN table N, an FTN table P, an ILM table N and an ILM table P. Each port linking a node with the MPLS TP ring may have the above four types of tables dedicatedly configured for the port, or four tables may be configured for multiple nodes, and this is not limited in this disclosure. The four types of tables in a node may be physically independent with respect to each other, or may share the same physical storage but may logically be separated.

The above are descriptions of blocks 201 and 202. The following is a description of block 203.

In an example, each node detects the current forwarding state of the node by using a general link connectivity detecting method or an MPLS TP section layer connectivity detecting method. In an example, a forwarding state variable (V) may be set to indicate the forwarding state of a node. When a node detects the node is connected with two adjacent nodes on the MPLS TP ring by using the above link connectivity detecting method or the MPLS TP section layer connectivity detecting method, the forwarding state variable is set to be a first value indicating that the node is in a normal forwarding state; when the node detects the node is disconnected from any adjacent node on the MPLS TP ring, the forwarding state variable is set to be a second value indicating that the node is in a protection forwarding state. Disconnection may be caused by a failure in an adjacent node or by a link failure between the node and an adjacent node. The forwarding state is set by default to be the normal forwarding state.

In the above block 203, after receiving a packet, a node checks the forwarding state variable, determines the node is in a normal forwarding state when the forwarding state variable is set to be the first value, and determines the node is in a protection forwarding state when the forwarding state variable is set to be the second value.

In the above description, the oL information may include at least a label value, a label operation to be performed (e.g., imposing a label, swapping a label, disposing a label, etc.), a corresponding egress port, and link layer encapsulation needed for forwarding the packet via the egress port. Based on the above first table and the second table, the packet forwarding procedure by using an MPLS forwarding table entry in the first table or in the second table in block 203 may include:

searching in the first table or in the second table for an MPLS forwarding table entry for forwarding the packet, forwarding the packet by using oL information in the MPLS forwarding table entry found. This procedure may be similar to conventional packet forwarding by using an outgoing label.

According to block 203, the forwarding state of a node is set to be the protection forwarding state as long as the connection with any adjacent node is disconnected, and the second table is searched for forwarding a received packet.

The technical scheme of the present disclosure, according to various examples, is as above described. The following is the description of an apparatus according to an example. FIG. 8 is a schematic diagram illustrating a structure of an apparatus according to an example. The apparatus is a node device in an MPLS TP ring. The node device may be a network device such as a switch or router etc. As shown in FIG. 8, the device may include: a first processing unit 801, a first table storing unit 802, a second processing unit 803, a second table storing unit 804 and a forwarding unit 805.

The first processing unit 801 is to add an MPLS forwarding table entry configured for a working LSP and an MPLS forwarding table entry configured for a backup LSP into a first table in the first table storing unit 802.

The second processing unit 803 is to add an MPLS forwarding table entry formed by cross connecting the working LSP and the backup LSP into a second table in the second table storing unit 804.

The forwarding unit 805 is to receive a packet, detect whether the node is in a normal forwarding state or a protection forwarding state, search in the first table stored in the first table storing unit 802 when the node is detected to be in a normal forwarding state, and forward the packet by using an MPLS forwarding table entry in the first table; search in the second table stored in the second table storing unit 804 when the node is detected to be in a protection forwarding state, and forward the packet by using an MPLS forwarding table entry in the second table.

The first table and the second table may be stored on physically separate storage media, or logically separated as two tables stored on the same physical storage medium.

As shown in FIG. 8, the node may further include:

a forwarding state managing unit 806, to manage a preset forwarding state variable. In an example, when the node is connected with two adjacent nodes in the MPLS TP ring, the forwarding state managing unit may set the forwarding state variable to be a first value indicating the node is in a normal forwarding state; when the node is disconnected from any adjacent node in the MPLS TP ring, the forwarding state managing unit may set the forwarding state variable to be a second value indicating that the node is in the protection forwarding state.

The forwarding unit 805 may check the forwarding state variable, determine the node is in the normal forwarding state when the forwarding state variable is set to be the first value, and determine that the node is in the protection forwarding state when the forwarding state variable is set to be the second value.

In an example, an MPLS forwarding table entry configured for a working LSP may be an FTN entry when the node is an ingress node of the working LSP or an ILM table when the node is not the ingress node of the working LSP.

An MPLS forwarding table entry configured for a backup LSP is an ILM entry.

The FTN entry configured for a working LSP may include a relation, which associates an FEC with oL information. The ILM entry configured for a working LSP may include a relation, which associates iL information with oL information on the working LSP. The ILM entry configured for a backup LSP may include: a relation which associates iL information with oL information on the backup LSP.

The first table may include: a first FTN table and a first ILM table.

For each working LSP traversing the node, the first processing unit:

may add an FTN entry configured for the working LSP into the first FTN table and add an ILM entry configured for a backup LSP of the working LSP into the first ILM table when the node is the ingress node of the working LSP;

may add an ILM entry configured for the working LSP and an ILM entry configured for the backup LSP of the working LSP into the first ILM table when the node is not the ingress node of the working LSP.

The second table may include: a second FTN table and a second ILM table.

For each working LSP traversing the node, the second processing unit:

may set oL information in an FTN entry configured for the working LSP to be oL information for the backup LSP of the working LSP, add the FTN entry into the second FTN table; and set oL information in the ILM entry configured for the backup LSP of the working LSP to be oL information for the working LSP, and add the ILM entry into the second ILM table when the node is the ingress node of the working LSP;

may set oL information in an ILM entry configured for the working LSP to be oL information for the backup LSP of the working LSP, set oL information in the ILM entry configured for the backup LSP of the working LSP to be oL information for the working LSP, and add the ILM entries into the second ILM table when the node is not the ingress node of the working LSP.

According to an example, the oL information may at least include: a label value, a label operation to be performed, a corresponding egress port, and link layer encapsulation needed for forwarding the packet via the egress port. The forwarding unit may search in the first table or the second table for an MPLS forwarding table entry for forwarding the packet when forwarding a packet by using MPLS forwarding table entries in the first table or the second table, and may forward the packet by using oL information in the MPLS forwarding table entry found.

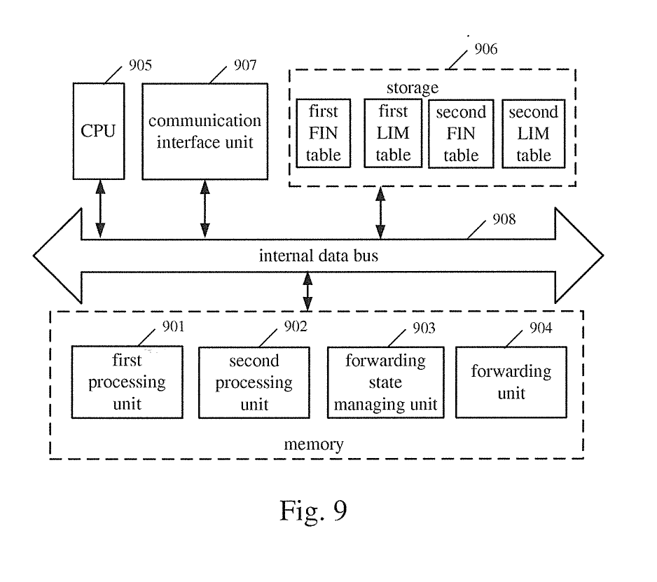

FIG. 9 is a block diagram of another example of a structure of a node device for use in an MPLS TP ring according to the present disclosure. As shown in FIG. 9, the apparatus comprises: a first processing unit 901, a second processing unit 902, a forwarding state management unit 903, and a forwarding unit 904 as in FIG. 8.

The apparatus also comprises a CPU 905, a storage 906, a communication interface unit 907, an internal data bus 908, and so on (which may be present in the example of FIG. 8 also, but are not shown in FIG. 8 for clarity). In the example shown in FIG. 9 the first processing unit, the second processing unit, the forwarding state management unit, and the forwarding unit are implemented as modules of machine readable instructions stored in a memory of the device and executable by the CPU. These modules may be stored in the same storage as the tables, or in another storage, and read into the memory prior to execution by the CPU. In an alternative implementation some or all of the modules, or certain functions thereof, may be provided by dedicated logic circuitry such as an ASIC etc.

In general, the above examples can be implemented by hardware, software, firmware, or a combination thereof. For example, the various methods and functional modules described herein may be implemented by a processor (the term processor is to be interpreted broadly to include a CPU, processing unit, ASIC,network processor (NP), logic unit, or programmable gate array etc.). The methods and functional modules may all be performed by a single processor or divided amongst several processers. The methods and functional modules may be implemented as machine readable instructions executable by one or more processors, hardware logic circuitry of the one or more processors, or a combination thereof. Further, the teachings herein may be implemented in the form of a machine readable instructions stored in a non-transitory storage medium, the instructions being executable by a processor to cause a computer device (e.g. a personal computer, a server or a network device such as a router, switch, access point etc.) to implement the method recited in the examples of the present disclosure.

From the above technical scheme it may be seen that by adopting the second table, which is searched when the node is disconnected from an adjacent node to perform packet forwarding by using MPLS forwarding table entries in the second table, there is no need to update entries in the ILM table or the FTN table, the time during which the traffic is interrupted is shortened, and the network self-healing capabilities are enhanced.

Further, by cross connecting a working LSP and corresponding backup LSP in advance, a temporary loop formed when the working LSP is switched to the backup LSP may be avoided.

The non-transitory machine readable storage media referred to in this disclosure may for example include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A multiprotocol label switching (MPLS) ring protection switching method applied to a node in an MPLS transport profile (TP) ring, said method comprising:
adding an MPLS forwarding table entry configured for a working label switched path (LSP) and an MPLS forwarding table entry configured for a backup LSP of the working LSP into a first table;
adding an MPLS forwarding table entry formed by cross connecting the working LSP and the backup LSP into a second table; and
receiving a packet and detecting whether the node is in a normal forwarding state or a protection forwarding state,
searching in the first table when detecting that the node is in the normal forwarding state, and forwarding the packet by using an MPLS forwarding table entry in the first table; and
searching in the second table when detecting that the node is in the protection forwarding state, and forwarding the packet by using an MPLS forwarding table entry in the second table.

2. The method of claim 1, further comprising:
setting a pre-set forwarding state variable to be a first value indicating that the node is in the normal forwarding state when the node is connected with two adjacent nodes in the MPLS TP ring;
setting the pre-set forwarding state variable to be a second value indicating that the node is in the protection forwarding state when a connection of the node with an adjacent node in the MPLS TP ring is disconnected; and
wherein detecting whether the node is in a normal forwarding state or in a protection forwarding state comprises:
checking the forwarding state variable, determining that the node is in the normal forwarding state when the forwarding state variable is set to be the first value, and determining that the node is in the protection forwarding state when the forwarding state variable is set to be the second value.

3. The method of claim 1, wherein the MPLS forwarding table entry configured for the working LSP comprises: a forwarding equivalence class (FEC) to next hop label forwarding entry (NHLFE) (FIN) entry configured for the working LSP when the node is an ingress node of the working LSP, or an incoming label map (ILM) table configured for the working LSP when the node is not an ingress node of the working LSP;
wherein the MPLS forwarding table entry configured for a backup LSP is an ILM entry;
wherein the FTN entry configured for the working LSP comprises a relation that associates a forwarding equivalent class (FEC) with outgoing label (oL) information; the ILM entry configured for the working LSP comprises a relation that associates ingoing label (iL) information with oL information on the working LSP; the ILM entry configured for the backup LSP comprises: a relation that associates iL information with oL information on the backup LSP.

4. The method of claim 3, wherein the first table comprises: a first FTN table and a first ILM table;
wherein adding an MPLS forwarding table entry configured for a working LSP and an MPLS forwarding table entry configured for a backup LSP into a first table comprises:
for each working LSP traversing the node,
adding an FTN entry configured for the working LSP into the first FTN table and adding an ILM entry configured for a backup LSP of the working LSP into the first ILM table when the node is an ingress node of the working LSP; and
adding an ILM entry configured for the working LSP and an ILM entry configured for the backup LSP of the working LSP into the first ILM table when the node is not an ingress node of the working LSP.

5. The method of claim 3, wherein the second table comprises:
a second FTN table and a second ILM table;
wherein adding an MPLS forwarding table entry formed by cross connecting the working LSP and the backup LSP into a second table comprises:
for each working LSP traversing the node,
adding into the second FTN table an FTN entry that is configured for the working LSP and in which oL information is set to be oL information for a backup LSP of the working LSP, and
adding into the second ILM table an ILM entry that is configured for a backup LSP of the working LSP and in which oL information is set to be oL information for the working LSP when the node is an ingress node of the working LSP;
setting oL information in an ILM entry configured for the working LSP to be oL information for a backup LSP of the working LSP, setting oL information in an ILM entry configured for the backup LSP of the working LSP to be oL information for the working LSP, and adding the ILM entries into the second ILM table when the node is not the ingress node of the working LSP.

6. The method of claim 3, wherein the oL information at least comprises a label value, a label operation to be performed, a corresponding egress port, and link layer encapsulation for forwarding a packet via the egress port;
wherein forwarding a packet by using an MPLS forwarding table entry in the first table or in the second table comprises:
searching in the first table or the second table for an MPLS forwarding table entry for forwarding the packet, and
forwarding the packet by using oL information in the MPLS forwarding table entry found.

7. A node device in a multiprotocol label switching transport profile (MPLS TP) ring, comprising:
a first processing unit, a first table storing unit, a second processing unit, a second table storing unit and a forwarding unit; wherein
the first processing unit is to add an MPLS forwarding table entry configured for a working label switched path (LSP) and an MPLS forwarding table entry configured for a backup LSP into a first table in the first table storing unit;
the second processing unit is to add an MPLS forwarding table entry formed by cross connecting the working LSP and the backup LSP into a second table in the second table storing unit;
the forwarding unit is to receive a packet, detect whether the node device is in a normal forwarding state or a protection forwarding state, search in the first table stored in the first table storing unit when the node device is detected to be in the normal forwarding state, and forward the packet by using an MPLS forwarding table entry in the first table, search in the second table stored in the second table storing unit when the node device is detected to be in the protection forwarding state, and forward the packet by using an MPLS forwarding table entry in the second table.

8. The node device of claim 7, further comprising:
a forwarding state managing unit to set a pre-set forwarding state variable to be a first value indicating that the node device is in the normal forwarding state when the node device is connected with two adjacent nodes in the MPLS TP ring and to set the forwarding state variable to be a second value indicating that the node device is in the protection forwarding state when a connection between the node device and an adjacent node in the MPLS TP ring is disconnected;
wherein the forwarding unit is to check the forwarding state variable, determine that the node device is in the normal forwarding state when the forwarding state variable is set to be the first value, and determine that the node device is in the protection forwarding state when the forwarding state variable is set to be the second value.

9. The node device of claim 7, wherein the MPLS forwarding table entry configured for the working LSP comprises: a forwarding equivalence class (FEC) to next hop label forwarding entry (NHLFE)(FTN) entry configured for the working LSP when the node device is an ingress node of the working LSP, or an incoming label map (ILM) table configured for the working LSP when the node device is not an ingress node of the working LSP;
wherein the MPLS forwarding table entry configured for the backup LSP is an ILM entry;
wherein the FTN entry configured for the working LSP comprises a relation that associates a forwarding equivalent class (FEC) with outgoing label (oL) information; the ILM entry configured for the working LSP comprises a relation that associates ingoing label (IL) information with oL information on the working LSP; and the ILM entry configured for the backup LSP comprises: a relation which associates iL information with oL information on the backup LSP.

10. The node device of claim 9, wherein the first table comprises: a first FTN table and a first ILM table;
wherein, for each working LSP traversing the node device, the first processing unit is to:
add an FTN entry configured for the working LSP into the first FTN table and add an ILM entry configured for a backup LSP of the working LSP into the first ILM table when the node device is the ingress node of the working LSP;
add an ILM entry configured for the working LSP and an ILM entry configured for the backup LSP of the working LSP into the first ILM table when the node device is not the ingress node of the working LSP.

11. The node device of claim 9, wherein the second table comprises: a second FTN table and a second ILM table;
wherein, for each working LSP traversing the node device, the second processing unit is to:
set oL information in an FTN entry configured for the working LSP to be oL information for the backup LSP of the working LSP, and add the FTN entry into the second FTN table; set oL information in the ILM entry configured for the backup LSP of the working LSP to be oL information for the working LSP, and add the ILM entry into the second ILM table when the node device is an ingress node of the working LSP;
set oL information in an ILM entry configured for the working LSP to be oL information for the backup LSP of the working LSP, set oL information in the ILM entry configured for the backup LSP of the working LSP to be oL information for the working LSP, and add the ILM entries into the second ILM table when the node device is not the ingress node of the working LSP.

12. The node device of claim 9, wherein the oL information at least comprises a label value, a label operation to be performed, a corresponding egress port, and link layer encapsulation for forwarding a packet via the egress port; and
wherein the forwarding unit is to search in the first table or the second table for an MPLS forwarding table entry for forwarding a packet, and forward the packet by using oL information in the MPLS forwarding table entry found.

13. The node device of claim 7, wherein the first table and the second table are stored in physically separate storage media.

14. The node device of claim 7, wherein the first table and the second table are stored in the same physical storage media.

15. A non-transitory machine readable storage media storing machine readable instructions which are executable by a processor of a node device to:
add an MPLS forwarding table entry configured for a working label switched path (LSP) and an MPLS forwarding table entry configured for a backup LSP of the working LSP into a first table;
add an MPLS forwarding table entry formed by cross connecting the working LSP and the backup LSP into a second table; and
receive a packet and detect whether the node device is in a normal forwarding state or a protection forwarding state,
search in the first table if the node is in the normal forwarding state, and forward the packet by using an MPLS forwarding table entry in the first table; and
search in the second table if the node device is in the protection forwarding state, and forward the packet by using an MPLS forwarding table entry in the second table.
